(19) United States
(12) Patent Application Publication
(10) Pub. No.: US 2014/0232646 A1
(43) Pub. Date: Aug. 21, 2014

(54) DIELECTRIC ELASTOMER MEMBRANE FEEDBACK APPARATUS, SYSTEM AND METHOD

(71) Applicant: Bayer Intellectual Property GmbH, Monheim (DE)

(72) Inventors: Silmon James Biggs, Los Gatos, CA (US); Roger N. Hitchcock, San Leandro, CA (US); Ilya Polyakov, San Francisco, CA (US); Alireza Zarrabi, Sunnyvale, CA (US)

(21) Appl. No.: 14/351,631

(22) PCT Filed: Oct. 19, 2012
(86) PCT No.: PCT/US2012/060973

§ 371 Date: Apr. 14, 2014

Related U.S. Application Data
(60) Provisional application No. 61/549,791, filed on Oct. 21, 2011.
(60) Provisional application No. 61/549,794, filed on Oct. 21, 2011.
(60) Provisional application No. 61/568,745, filed on Dec. 9, 2011.
(60) Provisional application No. 61/590,487, filed on Jan. 25, 2012.

(51) Int. Cl. G06F 3/01

(52) U.S. Cl. CPC G06F 3/016
USPC 345/156

(57) ABSTRACT

A feedback enabled system, module, and method are disclosed. The feedback enabled system comprises a first feedback module. The first feedback module comprises a membrane (thin film); a frame; a motion coupling, wherein when a voltage is applied to the membrane (thin film), the motion coupling exerts a force on the frame to provide feedback; and a user interface, wherein the first feedback module is configured to provide feedback through the user interface. The method comprises applying a first voltage with a first waveform to a first feedback module, the first feedback module comprising a dielectric elastomer membrane (thin film), a frame, and a motion coupling, wherein, when the first voltage is applied to the dielectric elastomer membrane (thin film), the motion coupling exerts a force on the frame.

### CROSS REFERENCE TO RELATED APPLICATION

This application claims the benefit, under 35 USC §119(e), of U.S. provisional patent application Nos. 61/549,791, filed Oct. 21, 2011, entitled “USER FREQUENCY PREFERENCES FOR MOBILE GAMING”; 61/549,794, filed Oct. 21, 2011, entitled “WEARABLE VESTIBULAR DISPLAY”; 61/568,745, filed Dec. 9, 2011, entitled “TABLET DRIVING CONCEPTS”; 61/590,487, filed Jan. 25, 2012, entitled “HAPTIC FEEDBACK DEVICE FOR GESTICULAR INTERFACES”; the entire disclosure of each of which is hereby incorporated by reference.

### BACKGROUND OF THE INVENTION

In various embodiments, the present disclosure relates generally to dielectric elastomer membrane (thin film) apparatuses, systems, and methods for providing haptic feedback to a user. More specifically, in one aspect the present disclosure relates to user frequency preferences for mobile gaming. In another aspect, the present disclosure relates to wearable vestibular displays. In yet another aspect, the present disclosure relates to techniques for driving tablet computers. Still in other aspects, the present disclosure relates to haptic feedback devices for gesticular interfaces.

Some hand held devices and gaming controllers employ conventional haptic feedback devices using small vibrators to enhance the user's gaming experience by providing force feedback vibration to the user while playing video games. A game that supports a particular vibrator can cause the device or gaming controller to vibrate in select situations, such as when firing a weapon or receiving damage to enhance the user's gaming experience. While such vibrators are adequate for delivering the sensation of large engines and explosions, they are quite monotonic and require a relatively high minimum output threshold. Accordingly, conventional vibrators cannot adequately reproduce finer vibrations. Besides low vibration response bandwidth, additional limitations of conventional haptic feedback devices include bulkiness and heaviness when attached to a device such as a smartphone or gaming controller.

Just as a visual display sends photons to the eye, a vestibular display sends accelerations to the balance organs of the inner ear. The purpose of a vestibular display is to make a user perceive linear and angular head accelerations, and changes in the apparent direction of gravity. At present, when a simulation requires a vestibular display, for example a flight simulator, the user must ride on a motion platform. This has the advantage of applying whole-body forces to the sensory organs of the skin and muscles as well as the inner ear. This is good for multimodal realism, since these sensors all contribute to the vestibular sense. Unfortunately, however, the cost and size of a motion platform limits the range of applications. Motion platforms aren't part of the typical home gaming system. The complexity, bulk, and expense of motion platforms are all significant drawbacks of the prior art such as the four degrees of freedom (4DOF) MOTIONSIM motion simulator by ELSACO Kolin, a company focused on the development and manufacture of electronic components for industrial automation.

Additionally, there is a need for an actuator configuration for a tablet computer that eliminates the need for flexible electrical connections, works in all use conditions with most direct-to-finger haptics, and is integrated as stand alone module. Additional needs include simple or easy moving-screen integration and final assembly.

Moreover, there is a need for a haptic or tactile feedback level of interactivity for the user of gesticular-based interfaces. With the advent of camera and three dimensional scanning based input devices such as the Kinect sensor, a user uses actual body parts to interact with user interface (UI) elements or game-play on the screen. While this adds a great level of interactivity for the user, it does take away the feedback of interacting with physical objects. So far the only feedback employed in similar systems is a rumble motor in Nintendo WII and PS3 control pendants that the user holds for both input and haptic feedback.

### SUMMARY OF THE INVENTION

To overcome these and other challenges experienced with conventional haptic feedback devices, the present disclosure provides electroactive polymer based feedback modules comprising dielectric elastomers having bandwidth and energy density that provide a suitable response in a compact form factor. Such electroactive polymer _{based} haptic feedback modules comprise a thin film, which comprises a dielectric elastomer film sandwiched between two electrode layers. When a high voltage is applied to the electrodes, the two attracting electrodes compress the entire film. The electroactive polymer based haptic feedback device provides a slim, low-powered haptic module that can be placed underneath an inertial mass (such as a battery) on a motion tray to amplify the haptic feedback produced by the host device audio signal between about 50 Hz and about 300 Hz (with a 5 ms response time).

In one embodiment of the present invention, a feedback enabled system is provided. The feedback enabled system comprises a first feedback module. The first feedback module comprises a thin film; a frame; a motion coupling, wherein when a voltage is applied to the thin film, the motion coupling exerts a force on the frame to provide feedback; and a user interface, wherein the first feedback module is configured to provide feedback through the user interface. The thin film can be a dielectric elastomer or piezoelectric film.

These and other advantages and benefits of the present invention will be apparent from the Detailed Description of the Invention herein below.

### BRIEF DESCRIPTION OF THE FIGURES

The novel features of the embodiments described herein are set forth with particularity in the appended claims. The various aspects, however, both as to organization and methods of operation may be better understood by reference to the following description, taken in conjunction with the accompanying drawings as follows.

FIG. 1 illustrates one embodiment of a vestibular display based on asymmetric rotational accelerations of a user's head;

FIG. 2 illustrates one embodiment of a vestibular perception hypothesis;

FIG. 3 illustrates a hand-held unit that generates asymmetric acceleration waveform shown in FIG. 4 that evoke a pulling feeling in the haptic system;

FIG. 4 illustrates an asymmetric acceleration waveform corresponding to the hand-held unit shown in FIG. 3 that evokes a pulling feeling in the haptic system;

FIG. 5 illustrates one embodiment of a headphones-integrated vestibular display comprising a vestibular display integrated with headphones

FIG. 6A is a graphical representation of accelerations experienced by a user such as changing walking direction,

FIG. 6B is a graphical representation of head yaw that results from accelerations experienced by a user such as changing walking direction,

FIG. 7 is a graphical representation of asymmetric accelerations of headphones containing inertial masses driven by dielectric elastomer actuators,

FIG. 8 is a graphical representation of head accelerations created by one embodiment of a vestibular display;

FIG. 9A illustrates one embodiment of a haptic module used in a haptics actuator;

FIG. 9B is a schematic diagram of one embodiment of a haptic system to illustrate the principle of operation;

FIG. 10 illustrates one embodiment of a game-enhancing case comprising a haptics module as described in connection with FIGS. 9A, 9B;

FIG. 11 is a simplified cross section of a game-enhancing case;

FIG. 12 is a system model to estimate forces F(t) that can be displayed to a user holding a case-shaped mass as shown in FIG. 13;

FIG. 13 is a system model of a user holding a case-shaped mass;

FIG. 14 is the mobility analog for the system in FIG. 13 as simulated in Personal computer Simulation Program with Integrated Circuit Emphasis (PSPICE);

FIG. 15 is a graphical representation of frequency responses of various haptic systems;

FIG. 16 is a graphical depiction of acceleration of the simulator and the prototype built with an actuator;

FIG. 17 is a graphical depiction of acceleration of the simulator and the prototype built with an actuator;

FIG. 18 illustrates waveforms used in a user study of a suitable actuator;

FIG. 19 is a screen shot of a graphical user interface (GUI) used to collect the data from each user;

FIG. 20 is graphical representation of rank ordering of design options;

FIG. 21 is a graphical representation of strength of preferences, which provides system rating compared to user's average rating;

FIG. 22 is perspective view of the haptic actuator;

FIG. 23 is top view of the haptic actuator shown in FIG. 22;

FIG. 24 is a side view of the haptic actuator shown in FIG. 22;

FIG. 25 is an exploded view of the haptic actuator shown in FIG. 22;

FIG. 26 provides a comparison of various drive systems for a tablet computer;

FIG. 27 is a diagram illustrating a suspended inertia drive system configuration for a tablet drive system;

FIG. 28 illustrates s perspective view of one embodiment of a haptic feedback device for gesticular interfaces;

FIG. 29 is top view of the haptic feedback device shown in FIG. 28;

FIG. 30 is a side view of the haptic feedback device shown in FIG. 28; and

FIG. 31 is another embodiment of a haptic feedback device that comprises of a full glove with smaller haptic actuator modules placed at the fingertips and haptic actuator modules placed on the palm.

### DETAILED DESCRIPTION OF THE INVENTION

Before explaining the disclosed embodiments in detail, it should be noted that the disclosed embodiments are not limited in application or use to the details of construction and arrangement of parts illustrated in the accompanying drawings and description. The disclosed embodiments may be implemented or incorporated in other embodiments, variations and modifications, and may be practiced or carried out in various ways. Further, unless otherwise indicated, the terms and expressions employed herein have been chosen for the purpose of describing the illustrative embodiments for the convenience of the reader and are not for the purpose of limitation thereof. Further, it should be understood that any one or more of the disclosed embodiments, expressions of embodiments, and examples can be combined with any one or more of the other disclosed embodiments, expressions of embodiments, and examples, without limitation. Thus, the combination of an element disclosed in one embodiment and an element disclosed in another embodiment is considered to be within the scope of the present disclosure and appended claims.

### Wearable Vestibular Display

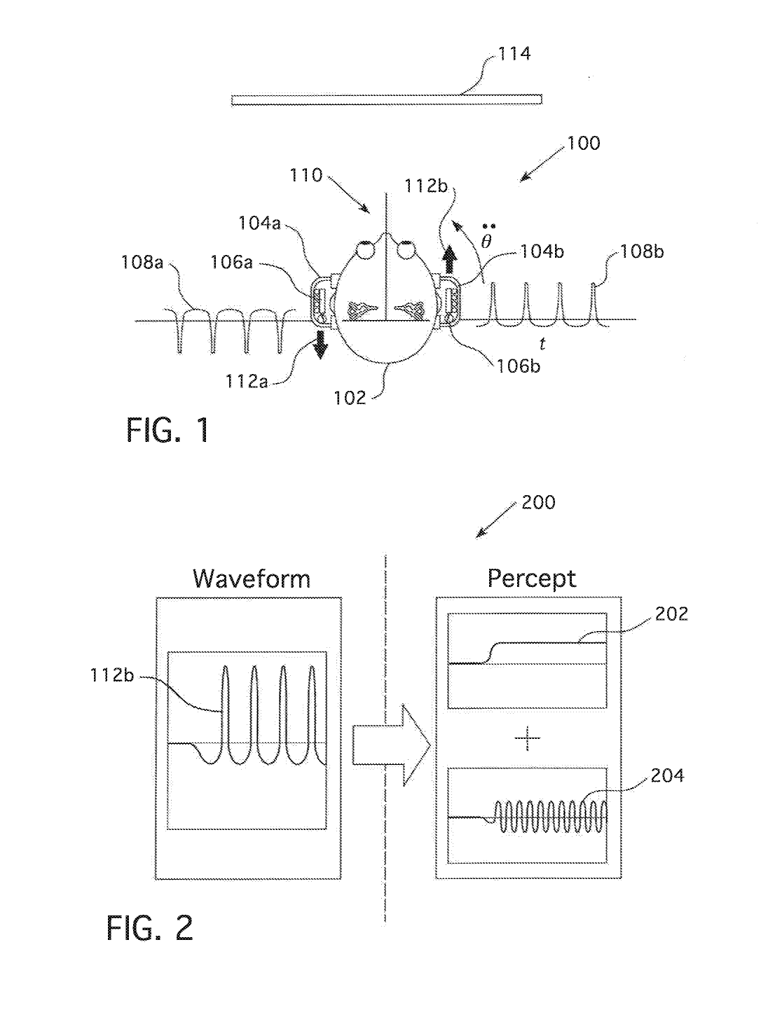

FIG. 1 illustrates one embodiment of a vestibular display 100 based on asymmetric rotational accelerations of a user's 110 (e.g., the subject's) head 102. The vestibular display system 100 stands in stark contrast to motion platform approaches described by prior art. As shown in FIG. 1, the vestibular display 100 is a compact, head-mounted system that can be integrated with conventional audio headphones 104a, 104b to maximize wearability and facilitate user acceptance. The vestibular display 100 is comprised of two or more independently controllable inertial modules 106a, 106b. Preferably, these modules 106a, 106b comprise dielectric elastomer actuators coupled to inertial masses, as discussed hereinbelow. These modules 106a, 106b can be driven to create low frequency audio sensations. As shown in FIG. 1, these modules 106a, 106b are driven with asymmetric waveforms 108a, 108b to create vestibular (balance) sensations indicated by angle θ. In one embodiment, the vestibular display 100 may be combined with a visual display 114. In such an embodiment, the user 110 may experience the vestibular display 100 while simultaneously observing a large field of view on the visual display 114 which may depict curvilinear motion, for example.

Additional description of independently controllable inertial modules can be found in commonly owned international PCT application number PCT/US20121026421, filed Feb. 24, 2012, entitled “AUDIO DEVICES HAVING ELECTROACTIVE POLYMER ACTUATORS”, the entire disclosure of which is hereby incorporated by reference.

FIG. 2 illustrates one embodiment of a vestibular perception hypothesis 200. With reference to FIGS. 1 and 2, the purpose of the asymmetric waveforms 108a, 108b is to make the user 110 perceive directional accelerations of the head 102, not just vibrations. Brief, intense accelerations in one direction 112b alternate with longer, less intense accelerations in the opposite direction 112a. These accelerations perturb the discharge rates of nerve endings in the vestibular organs of the ear—the semicircular canal and otoliths. Mechanically, these accelerations integrate to zero over time so there is no net rotation of the head 102. Perceptually, however, the nervous system is not a perfect integrator. Imperfect integration of these signals by the nervous system must create a perception of net head 102 rotation 202 superimposed on the vibration 204.

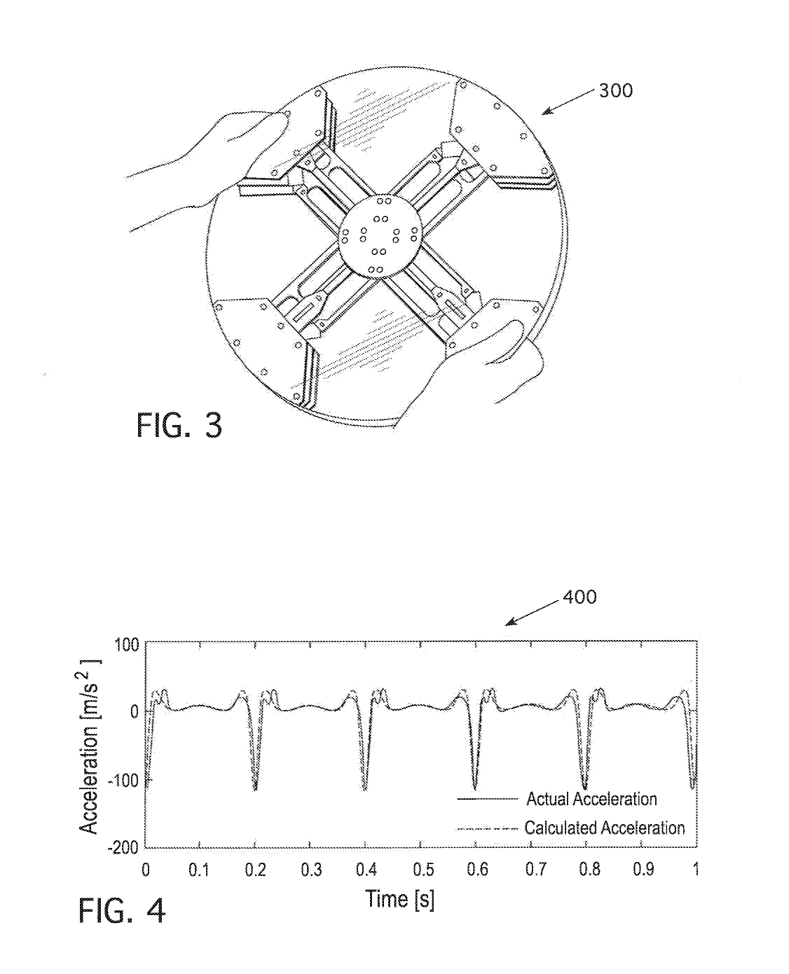

FIG. 3 illustrates a hand-held unit 300 that generates asymmetric acceleration waveform 400 shown in FIG. 4 that evokes a pulling feeling in the feedback system. The asymmetric acceleration waveform 400 is graphically depicted with acceleration (−200 to +100 m/s²) on the vertical axis and time (0-1 s) on the horizontal axis. The asymmetry is about 9 g at a frequency of about 5 Hz. Additional information of similar asymmetric acceleration systems may be found in Tomohiro Amemiya, Haptic Direction Indicator For Visually Impaired People Based On Pseudo-Attraction Force, e-Minds 1(5) (March 2009), ISSN: 1697-9613 (print)-1887-3022 (online), www.eminds.hci-rq.com, which is herein incorporated by reference. This technique works in a haptic system configuration such as the vestibular display 100 described in connection with FIG. 1. A handheld unit 300 that generates asymmetric accelerations at 3-9 Hz (FIG. 3) can direct visually impaired users. Users experience a net force sensation in the direction of the brief ˜10 g pulses that point the way to go. When the axis of acceleration is oriented vertically, turning on the handheld unit 300 makes it feel heavier. In a separate study on a magnetically levitated haptic display, pulses in the 2-6 Hz range all gave satisfactory results. The lowest frequency provided the clearest direction signal as described in Tappeiner-H W, Klatzky-R L, Unger-B, Hollis-R, Good Vibrations: Asymmetric Vibrations For Directional Haptic Cues, Third Joint Eurohaptics Conference And Symposium On Haptic Interfaces For Virtual Environment And Teleoperator Systems, Salt Lake City, Utah, USA, Mar. 18-20, 2009, which is herein incorporated by reference. However, at frequencies below 3 Hz the accelerations no longer fuse into a single perception and the stimulus takes on the character of discrete tugs.

Evoking similar illusions in a user's vestibular system is supported not only by recent developments in haptic systems, but also by recent studies of the vestibular-ocular reflex. For example, recent studies show that the vestibular-ocular reflex (YOR) has an amazing sensitivity (−70 dB re 1 g) to head vibrations of about 100 Hz as described in Todd-N P M, Rosengren-S M Colebatch-J G, Tuning And Sensitivity Of The Human Vestibular System To Low Frequency Vibration, Neuroscience Letters 444 (2008) 36-41, apparently due to mechanical resonance of the utricles, as described in Todd-N P M, Rosengren-S M Colebatch-J G, A Utricular Origin Of Frequency Tuning To Low-frequency Vibration In The Human Vestibular System, Neuroscience Letters, Volume 454, Issue 1, 17 Apr. 2009, Page 110, each of which is incorporated herein by reference. That involuntary eye movements can be stimulated by such vanishingly small accelerations bodes well for the power requirements of a head-mounted vestibular display 100.

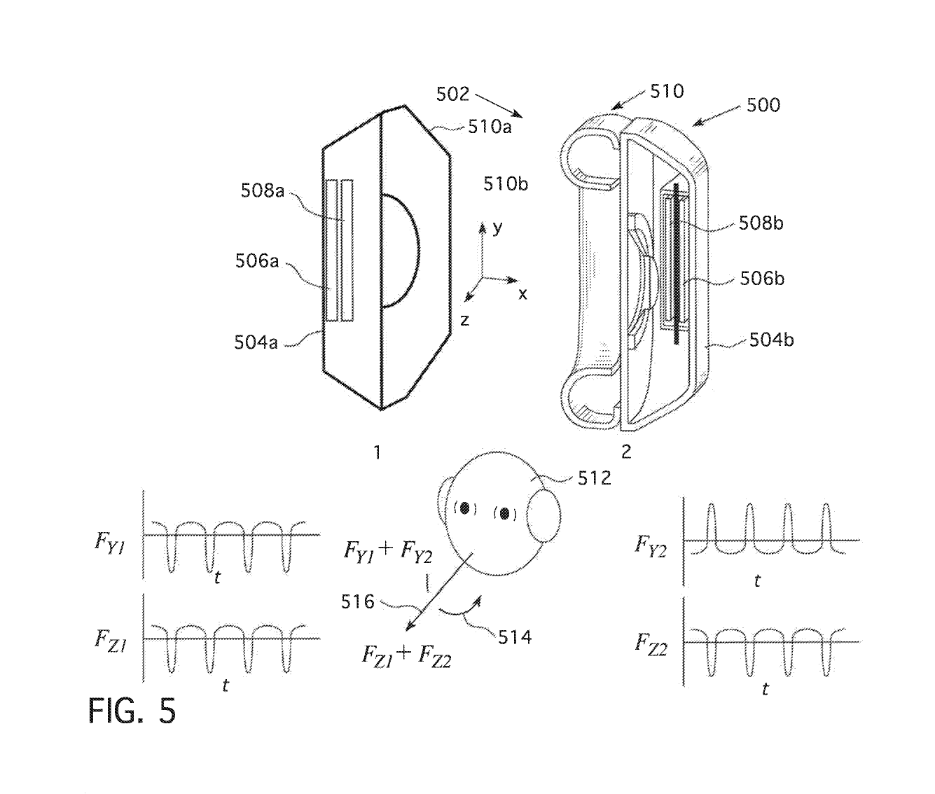

FIG. 5 illustrates one embodiment of a headphones-integrated vestibular display 500 comprising a vestibular display integrated with headphones. The vestibular system 500 combining three elements: 1) a head-mounted system 502 comprising headphones 504a, 504b; 2) inertial drive modules 506a, 506b, 508a, 508b; and 3) asymmetric acceleration waveforms F_{Y1}, F_{Z1}, F_{Y2}, and F_{Z2}. This example has four separate inertial drives including forward/back inertial drive modules (x) 506a, 506b and up/down inertial drive modules (y) 508a, 508b. In addition, cushions 510a, 510b provided on the headphones 504a, 504b provide higher than normal shear stiffness for good mechanical coupling. Driving the two sides 1 and 2 out of phase with waveforms {F_{Y1} and F_{Y2}} gives the user 512 vestibular input consistent with rotational acceleration as indicated by rotational arrow 514. Driving the two sides 1 and 2 with in phase waveforms {F_{Z1} and F_{Z2}} gives the user 512 vestibular input consistent with linear acceleration as indicated by linear arrow 516.

Applications for vestibular displays include video games, navigation in virtual environments, flight simulators, and balance disorders, among others. Home video game systems such as XBOX, WII, and PLAYSTATION, for example, are widespread. Peripherals are a diverse market that includes high-fidelity headphones, force-feedback joysticks, rumble chairs, and so on. Games that involve turning a race car, flipping a snowboard, and riding a rollercoaster may all be enhanced by hardware that renders these strong vestibular sensations.

Users navigating in virtual environments tend to get lost. For example, a user trying to turn 90° right, using only the visual cues provided by a head mounted display, typically tends to overshoot the turn, presumably due to the lack of vestibular cues. A single 170° turn is enough to disorient most users badly enough that they cannot correctly point back to their starting location. Although this may be a nuisance for a gaming enthusiast trying to navigate a virtual “Death Star”, for example, this disorientation may present a serious problem for the military. Soldiers increasingly use simulations to prepare for missions. It is useful to rehearse the route to a cabin in a ship the troops will board, but not if they become disoriented in the simulation. A wearable vestibular display 500 as disclosed herein may help alleviate this problem.

Motion platforms for flight simulators are expensive, specialized pieces of equipment. An obstacle which has led many military and civilian pilot training organizations to adopt some level of “platform-free” simulation. The quality of these simulations may be improved by the addition of a head-mounted vestibular display 500 as described herein, particularly for practicing “blind” instruments-only approaches.

The wearable vestibular display 500 disclosed herein also may be employed as a diagnostic tool to detect, and possibly to treat, some balance disorders of the vestibulo-ocular system, such as vestibular nystagmus.

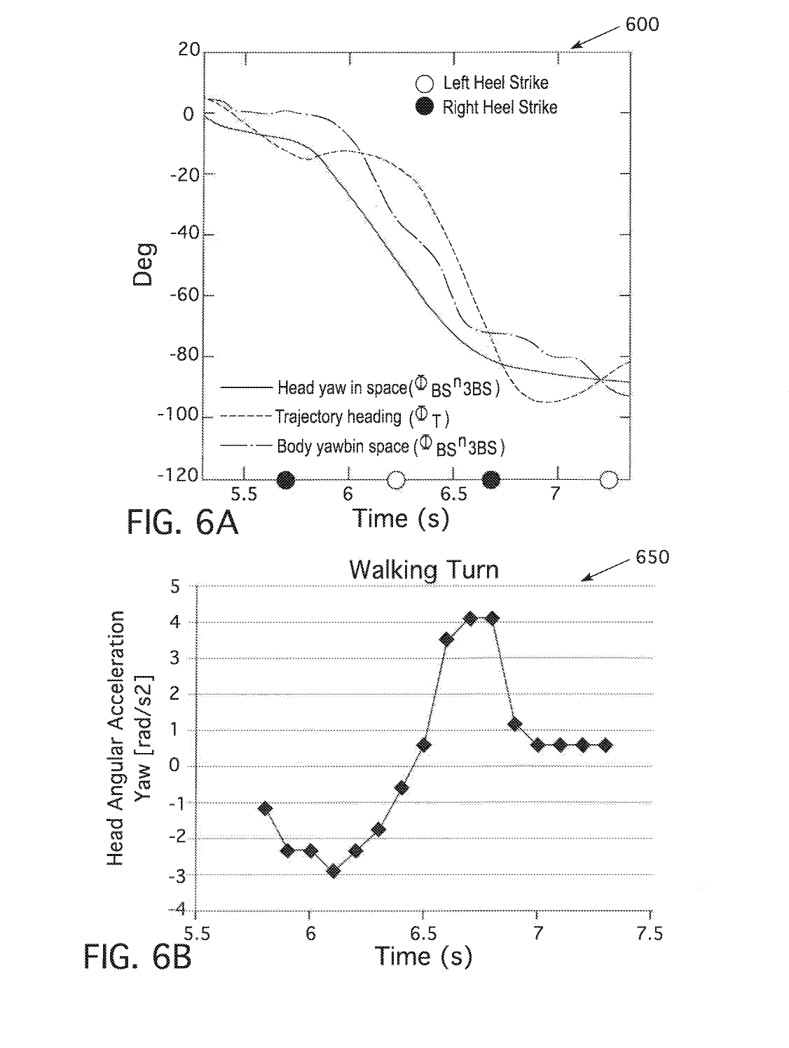

FIG. 6A is a graphical representation 600 of accelerations experienced by a user such as changing walking direction and FIG. 6B is a graphical representation 650 of head yaw that results from accelerations experienced by a user such as changing walking direction. Changing walking direction (90°, r=50 cm) yaws the head. Smoothing the data and differentiating twice reveals that this typical activity generates head accelerations of a few radians per second squared. At the time of the present invention, it has been possible to collect preliminary data on headphones retro-fitted with inertial drives to approximate the vestibular displays 100, 500 shown in FIGS. 1 and 5, for example. Although such headphones retro-fitted with inertial drives were developed with only audio in mind, their properties are similar from what is required to make a vestibular display 100, 500 as described in connection with FIGS. 1 and 5.

First, it is useful to have some context about what sort of accelerations are believed by the present inventors to be required for vestibular displays 100, 500. Moderate activities, for example walking through a 90 degree turn, involve turning the head during a period of about one second, as shown in FIG. 6A. Differentiating these published measurements twice reveals that the turn involves head accelerations of about 4 rad/s² in yaw as shown in FIG. 6B.

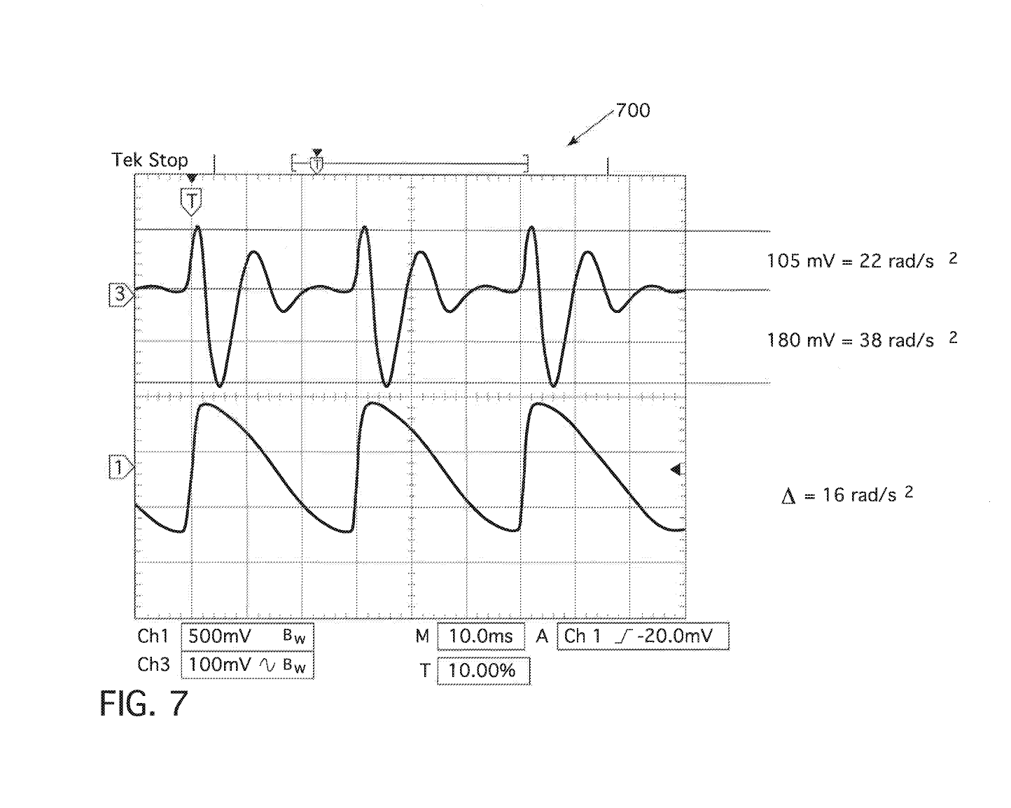

FIG. 7 is a graphical representation 700 of asymmetric accelerations of headphones 104a, 104b (504a, 504b in FIG. 5) containing inertial masses driven by dielectric elastomer actuators, as described hereinbelow. Given that context, consider measurements of the inertial modules 106a, 106b described in connection with FIG. 1. Such measurements indicate rotational accelerations with an asymmetry of 16 rad/s² can be produced in headphones with 25 gram inertial modules 106a, 106b driven by three-bar, four-layer, two-phase haptic actuators driven at 1 kV. The inertial modules 106a, 106b were driven with asymmetric waveforms 108a, 108b as shown in FIG. 1, so movement was horizontal, and 180° out of phase. As the hardware stands, maximum asymmetry occurs when the inertial modules 106a, 106b of the headphones 104a, 104b (504a, 504b in FIG. 5) are driven by a sine wave with a fundamental frequency of about 34 Hz. Limiting asymmetry to 80% limited unwanted audio to an acceptable level (bottom trace). With these settings, the headphones 104a, 104b accelerate with an asymmetry of about 16 rad/s², which is about four-fold larger than the accelerations observed in a typical walking turn as shown in FIG. 6A.

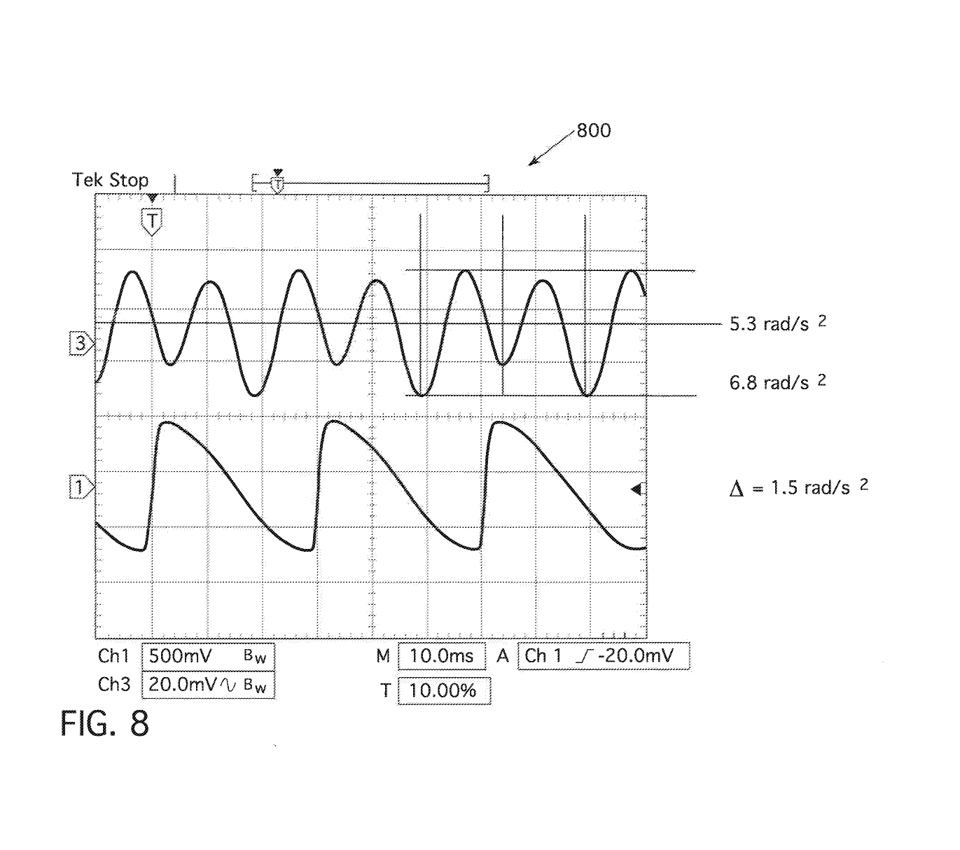

FIG. 8 is a graphical representation 800 of head accelerations created by one embodiment of a vestibular display 100, 500. In one embodiment, the accelerations have an asymmetry of 1.5 rad/s², about half of the yaw acceleration experienced during a normal walking turn. Note the scale change from 100 mV to 20 mV per division compared to FIG. 7. Although the headphones 104a, 104b (504a, 504b in FIG. 5) can provide a reasonable asymmetric waveform at this frequency, the compliant foam coupling of the headphones to the user's head attenuated these accelerations too much. An accelerometer mounted on the user's head recorded a maximum asymmetry of about one tenth of the headphone asymmetry. A less compliant foam would attenuate the acceleration less for a more intense experience.

These results suggest that the haptic headphone meet the requirements for vestibular displays 100, 500 (FIGS. 1 and 5, for example). In another embodiment, better mechanical coupling may be provided by modifying the headphones 104a, 104b and 504a, 504b. For example, as discussed in connection with FIG. 5, for example, the cushion 510a, 510b may be formed with a higher than normal shear stiffness for good mechanical coupling to the user's head. If the carrier frequency (34 Hz) is in the wrong range, a suitable range may be determined using a muscle-lever set up. The MATLAB code for the muscle lever tests of asymmetric acceleration is provided below:

%tone_simple.m plays tones with asymmetric acceleration,

alternating direction

| | |
|---|---|
| daqF=2*8092; | % output frequency [sample/s] |
| lambda0 = 0.08; | % 0.5 is equal |

| | |
|---|---|
| T=0.07; | %[s] |
| dur=1.0; | %[s] |

| | |
|---|---|
| abs_impulse_per_sec = 0.03; | %abs([Ns])/s |

| | |
|---|---|
| impulse = abs_impulse_per_sec*T; | %[Ns] |

dataOUT = 0;
for i = 0:7,

if rem(i,2)<0.1,

lambda=lambda0;

else lambda = 1−lambda0;
end
A1=impulse/(lambda*T);
[temp] = a_wav(daqF, A1, lambda, T, dur);
dataOUT = [dataOUT; temp];

end
% haptic output
press_detect = 2; %[V]
adjustments = 1000; % # times user adjusts wave
test_period = 1; % [sec] time to try out each click
scale = (1/1.44); %calibrated [V/N]
dataOUT = dataOUT*scale;
%mov avg filter to try smoothing
w=10;
for j=1:length(dataOUT)−w

dataOUT(j)=mean(dataOUT(j:j+w));

end
% set up to run the
DAQ%%%%%%%%%%%%%%%%%%%%%%%%%%%%%%%%%%
%%
ichans=[0 1 2];
inputrange = [10 10 5];
ai_pts = 2;
%%%%%%%%%%%%%%%%%%%%%%%%%%%%%%%%%%%%%
%%
% Create DAQ devices for output and input
ai = analoginput(‘nidaq’,‘Dev1’);
ao = analogoutput(‘nidaq’,‘Dev1’);
set(ai,‘InputType’,‘SingleEnded’);
% Add ouput channel to the device
addchannel(ao,0);
% Add input channels to the device
for i = 1:length(ichans)

addchannel(ai,ichans(i));
set(ai.channel(i),‘InputRange’, inputrange(i)*[−1 1]);

end
% Configure devices and channels
set(ai,‘TransferMode’, ‘Interrupts’);
set([ao ai], ‘TriggerType’, ‘Immediate’);
set(ai,‘SamplesPerTrigger’, ai_pts);
set([ao ai], ‘SampleRate’, daqF);
%%%%%%%%%%%%%%%%%%%%%%%%%%%%%%%%%%%%%
%%%
%load and scale the data
%load tone1.txt
%effect1 = tone1;
%dataOUT=scale*effect1;
% output the data
putdata(ao,dataOUT);
start(ao);
pause(length(dataOUT)/daqF);
stop(ao);
% clean up
sigset(0)
stop([ao ai])
delete([ao ai])
clear ao ai;
%
% [dataOUT] = a_wav(daqF, A1, lambda, T, dur)
%
% daqF = sample/s
% A1 = Amplitude [N] of first half of acceleration
% lambda = asymmetry (0.5 = equal)
% T = period [s]
% dur = duration of output file [s]
%
% a_wav.m returns a waveform of asymmetric acceleration suitable for
daq outupt
%
%
function [dataOUT] = a_wav(daqF, A1, lambda, T, dur)
cycle_length = floor(daqF*T/dur);
zero_cross = floor(lambda*cycle_length);
A1_length = zero_cross;
A2_length = cycle_length−zero_cross;
A2 = −A1*lambda/(1−lambda);
one_cycle = [[A1*ones(A1_length, 1)] ; [A2*ones(A2_length,1)]];
n_cycle = floor(dur/T);
dataOUT = repmat(one_cycle, n_cycle,1);
% taper the amplitude of the end of the wave
taper_start = floor(daqF*(0.75*dur));
taper_length = length(dataOUT)−taper_start;
taper_values = [[taper_length: −1 : 1]/taper_length]′;
dataOUT(taper_start+1:end,1) =
dataOUT(taper_start+1:end).*(taper_values);

Some US patent literature disclosing head mounted systems related to vestibular-ocular function include: U.S. Pat. Nos. 7,892,180; 7,651,224; 7,717,841; 7,730,892; and 7,488,284, each of which is herein incorporated by reference. None of these references, however, disclose a head-mounted vestibular display based on the principle of asymmetric acceleration.

Additional references include: Tomohiro Amemiya, Haptic Direction Indicator For Visually Impaired People Based On Pseudo-Attraction Force, e-Minds 1(5) (March 2009), ISSN: 1697-9613 (print)-1887-3022 (online), www.eminds.hci-rg.com; Bernhard E. Riecke, Jan M. Wiener, Can People Not Tell Left From Right In VR? Point-To-Origin Studies Revealed Qualitative Errors In Visual Path Integration, pp. 3-10, 2007 IEEE Virtual Reality Conference, 2007; Imai-T, Moore-S, Raphan-T, Cohen-B, Interaction Of The Body, Head, And Eyes During Walking And Turning, Exp. Brain Res (2001) 136:1-18; Angelak-D E, Cullen-K E, Vestibular System: The Many Facets Of A Multimodal Sense, Annu. Rev. Neurosci. (2008) 31:125-150; Tappeiner-H W, Klatzky-R L, Unger-B, Hollis-R., Good Vibrations: Asymmetric Vibrations For Directional Haptic Cues, Third Joint Eurohaptics Conference And Symposium On Haptic Interfaces For Virtual Environment And Teleoperator Systems, Salt Lake City, Utah, USA, Mar. 18-20, 2009; Amemiya-T, Ando-H, Maeda-T, (Chapter), Kinesthetic Illusion Of Being Pulled Sensation Enables Haptic Navigation For Broad Social Applications, Advances in Haptics (Edited by Mehrdad Hosseini Zadeh), In-Tech, ISBN 978-953-307-093-3, pp. 403-414, April 2010; Todd-N P M, Rosengren-S M Colebatch-J G, Tuning And Sensitivity Of The Human Vestibular System To Low Frequency Vibration, Neuroscience Letters 444 (2008) 36-41; Todd-N P M, Rosengren-S M Colebatch-J G, A Utricular Origin Of Frequency Tuning To Low-frequency Vibration In The Human Vestibular System?, Neuroscience Letters, Volume 454, Issue 1, 17 Apr. 2009, Page 110. Each of these references is herein incorporated by reference.

### User Frequency Preferences for Mobile Gaming

In service, gaming devices, such as those which implement the independently controllable inertial modules 106a, 106b of the vestibular display 100 and the inertial drive modules 506a, 506b, 508a, 508b of the vestibular display 500 discussed in connection with FIGS. 1 and 5, have a frequency-dependent performance envelope. Generally, the perceived intensity is at maximum at the resonant frequency, and falls off at higher and lower frequencies. Selecting an actuator means setting the resonant frequency so that bass/treble response is well balanced. To measure how users respond to this balance, the dynamics of game-enhancing smart phone cases (e.g., IPOD case, handset, and the like) built with four actuator designs were modeled. Haptic tones representative of the performance envelopes of the various systems were displayed to users through custom hardware. In a study of sixteen users given a choice between haptic systems with resonant frequencies that were low (51 Hz), mid-range (72 and 76 Hz) and high (107 Hz), users significantly preferred the mid-range systems, which provided a balance of bass and treble response.

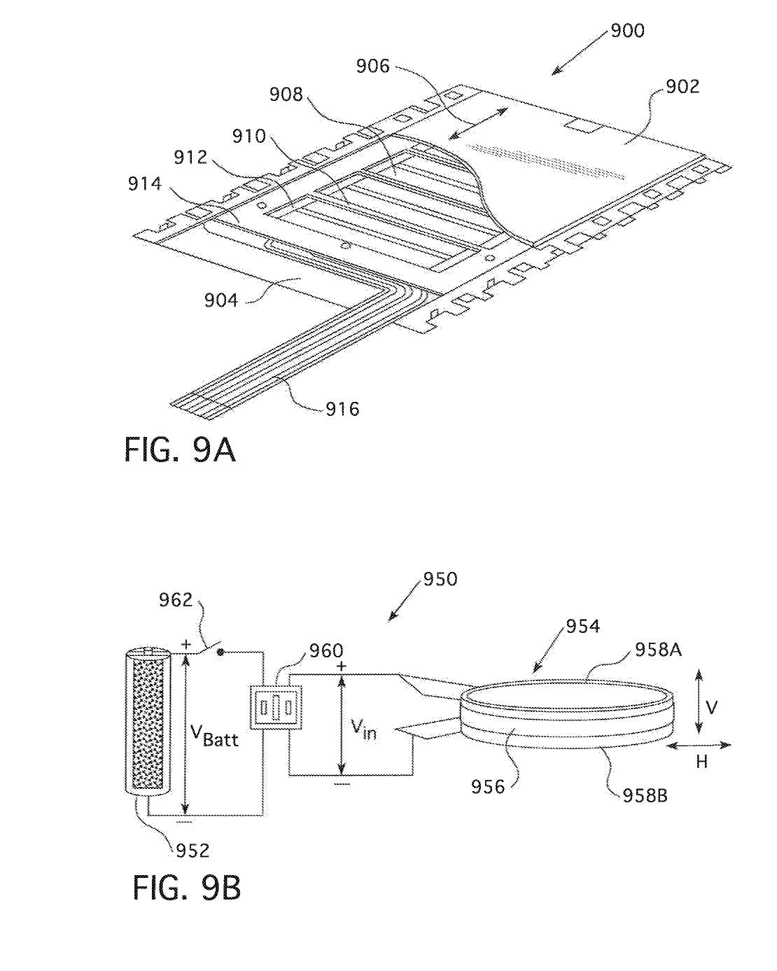

FIG. 9A illustrates one embodiment of a haptic module 900 (e.g., a haptic cartridge) used in a haptics actuator. The haptic module 900 is a thin dielectric elastomer cartridge that can be integrated with handsets, video game controllers, touch screens, and other consumer electronics. The haptic module 900 enables these devices to produce haptic effects with rise time <<5 ms and a bandwidth (50-250 Hz) that is superior to conventional technologies, such as eccentric mass motors. In mobile gaming, for example, the haptic module 900 renders a variety of compelling effects, including weapon-specific recoil, engine-specific rumble, and distinctive race-track textures. The haptic module 900 comprises a plurality of electrodes and bars that produce a force when actuated by an electric potential, as described in more detail hereinbelow. Similar modules can be used to provide other forms of feedback such as audio or sonic responses.

FIG. 9A illustrates one embodiment of an electroactive polymer cartridge based actuator framed or frameless haptic feedback modules that may be integrally incorporated with hand held devices (e.g., devices, gaming controllers, consoles, and the like) to enhance the user's vibratory feedback experience in a light weight compact module. Accordingly, one embodiment of a haptic system is now described with reference to a fixed plate type haptic module 900. A haptic actuator slides an output plate 902 (e.g., sliding surface) relative to a fixed plate 904 (e.g., fixed surface) when energized by a high voltage. The plates 902, 904 are separated by steel ball bearings, and have features that constrain movement to the desired direction, limit travel, and withstand drop tests. For integration into a device, the top plate 902 may be attached to an inertial mass such as the battery or the touch surface, screen, or display of the device. In the embodiment illustrated in FIG. 9B, the top plate 902 of the haptic module 900 is comprised of a sliding surface mounted to an inertial mass or back of a touch surface that can move bi-directionally as indicated by arrow 906. Between the output plate 902 and the fixed plate 904, the haptic module 900 comprises at least one electrode 908, at least one divider segment 910, and at least one bar 912 that attaches to the sliding surface, e.g., the top plate 902. A rigid frame 914 and the divider segments 910 attach to a fixed surface, e.g., the bottom plate 904. The haptic module 900 may comprise any number of bars 912 configured into arrays to amplify the motion of the sliding surface. The haptic module 900 may be coupled to the drive electronics of an actuator controller circuit via a flex cable 916.

Advantages of the electroactive polymer based haptic module 900 include providing force feedback sensations to the user that are more realistic through the use of arbitrary waveforms, can be felt substantially immediately, consume significantly less battery life, and are suited for customizable design and performance options. The haptic module 900 is representative of haptic modules developed by Artificial Muscle Inc. (AMI), of Sunnyvale, Calif.

Still with reference to FIG. 9A, many of the design variables of the haptic module 900, (e.g., thickness, footprint) may be fixed by the needs of module integrators while other variables (e.g., number of dielectric layers, operating voltage) may be constrained by cost. actuator geometry—the allocation of footprint to rigid supporting structure versus active dielectric—is a reasonable way to tailor performance of the haptic module 100 to an application where the haptic module 100 is integrated with a device.

Computer implemented modeling techniques can be employed to gauge the merits of different actuator geometries, such as: (1) Mechanics of the Handset/User System; (2) Actuator Performance; and (3) User Sensation. Together, these three components provide a computer-implemented process for estimating the haptic capability of candidate designs and using the estimated haptic capability data to select a haptic design suitable for mass production. The model predicts the capability for two kinds of effects: long effects (gaming and music), and short effects (key clicks). “Capability” is defined herein as the maximum sensation a module can produce in service. Such computer-implemented processes for estimating the haptic capability of candidate designs are described in more detail in International PCT Patent Application No. PCT/US2011/000289, filed Feb. 15, 2011, entitled “HAPTIC APPARATUS AND TECHNIQUES FOR QUANTIFYING CAPABILITY THEREOF,” the entire disclosure of which is hereby incorporated by reference.

Additional disclosure of haptic feedback modules integrated with the device for moving and/or vibrating surfaces and components of a device are described in commonly assigned and concurrently filed International PCT Patent Application No. PCT/US2012/021506, filed Jan. 17, 2012, entitled “FLEXURE APPARATUS, SYSTEM, AND METHOD,” the entire disclosure of which is hereby incorporated by reference.

FIG. 9B is a schematic diagram of one embodiment of a haptic system 950 to illustrate the principle of operation. The haptic system 950 comprises a power source 952, shown as a low voltage direct current (DC) battery, electrically coupled to a haptic module 954. The haptic module 954 comprises a thin elastomeric dielectric 956 disposed (e.g., sandwiched) between two conductive electrodes 958A, 958B. In one embodiment, the conductive electrodes 958A, 958B are stretchable (e.g., conformable) and may be printed on the top and bottom portions of the elastomeric dielectric 956 using any suitable techniques, such as, for example screen printing. The haptic module 954 is activated by coupling the battery 952 to an actuator circuit 960 by closing a switch 962. The actuator circuit 960 converts the low DC voltage V_{Batt} into a high DC voltage Vᵢₙ suitable for driving the haptic module 954. When the high voltage Vᵢₙ is applied to the conductive electrodes 958A, 958B the elastomeric dielectric 956 contracts in the vertical direction (V) and expands in the horizontal direction (H) under electrostatic pressure. The contraction and expansion of the elastomeric dielectric 956 can be harnessed as motion. The amount of motion or displacement is proportional to the input voltage Vᵢₙ.

Having described one embodiment of a haptic module 900 generally, the description now turns to a haptic cartridge enabled device having a frequency-dependent performance envelope. What the user feels depends on several factors: (1) the masses of the moving bodies in the system, (2) the mechanics of the user's hand, (3) the user's sensitivity to vibrations of various frequencies, and (4) the spring rate, blocked force, and damping of the actuator in the system. In many cases it is only the last factor, the actuator, that the designer can determine.

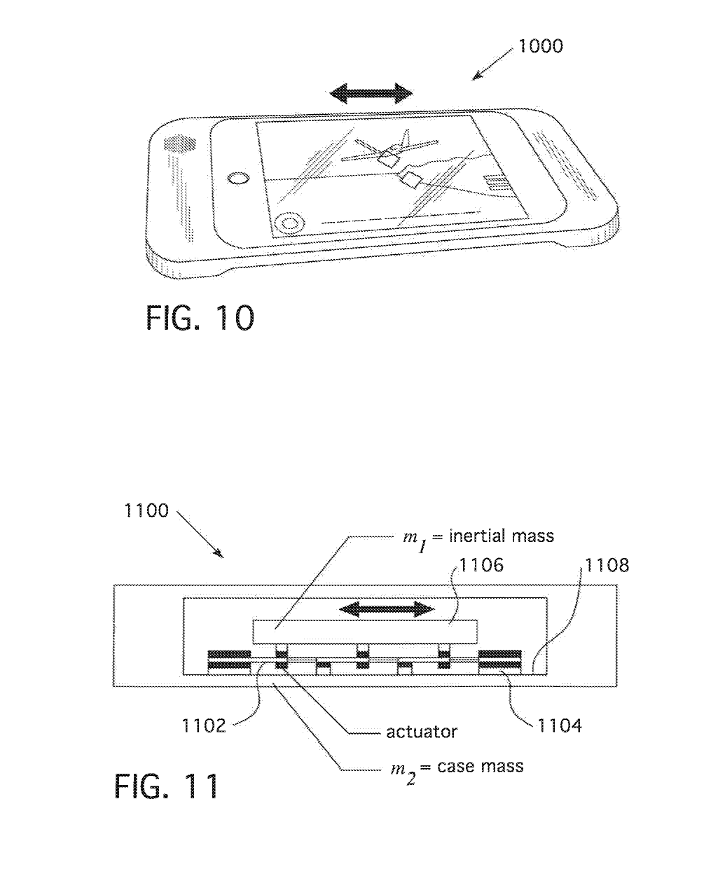

FIG. 10 illustrates one embodiment of a game-enhancing case 1000 comprising a haptics module as described in connection with FIGS. 9A, 9B. In prior work, the present inventors presented a model of a haptics-enabled handset that included all four factors, and enabled a system designer to estimate the tactile intensity that users would perceive at various frequencies. Although the model quantified the fundamental trade-offs in system design—strong bass versus strong treble—it could not predict what sort of bass/treble trade-off users prefer. Studies have been conducted to address these preferences, essentially asking: “Given the frequency-dependent capabilities a haptic device built with one of four different candidate actuators, what system do users prefer?” The problem is analogous to designing a piano, which has some peak loudness at each note on the keyboard. Here the present inventors provide an approach to simulating candidate haptic systems, hardware for playing the resulting effects for users, and the results of a user study to determine optimal actuator designs for various applications.

FIG. 11 is a simplified cross section of a game-enhancing case 1100. A haptic module 1102 or cartridge is comprised of a dielectric elastomer thin film constrained by a rigid frame that defines multiple windows, with an output bar in each window, as previously discussed with respect to FIGS. 9A, 9B. When voltage is applied to the stretchable electrodes 1104 (dark regions), the output bars exert a force proportional to the square of the electric field through the thin film. For inertial haptic feedback, the actuator bars are coupled to an overlying inertial mass 1106 and the actuator frame 1108 is coupled to the inside of the case 1108.

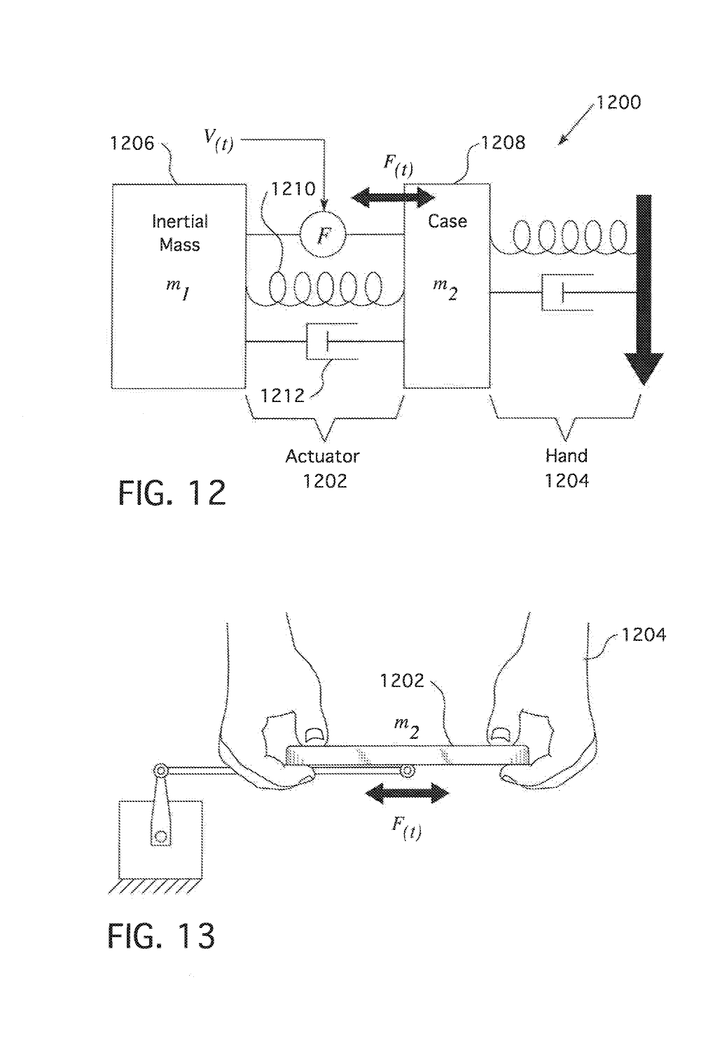

FIG. 12 is a system model 1200 to estimate forces F(t) that can be displayed to a user holding a case-shaped mass as shown in FIG. 13. The haptic device is described with a linear time invariant model 1200 as an actuator 1202 and a hand 1204. The actuator 1202 is modeled as an inertial mass m₁ 1206 and a case mass m₂ 1208 coupled by a linkage 1210 and a damper 1212. It is straightforward to simulate this system in PSPICE, and to solve the forces F(t) that the inertial drive exerts on the inside of the case. For user testing, these forces were reproduced with a high precision force source attached by a linkage to a custom case with mass m₂ 1208. When a user holds the case, he or she experiences the forces F(t) that an enclosed inertial drive would have produced. Different actuator designs have different forces, spring rates, and damping, and therefore present different performance envelopes.

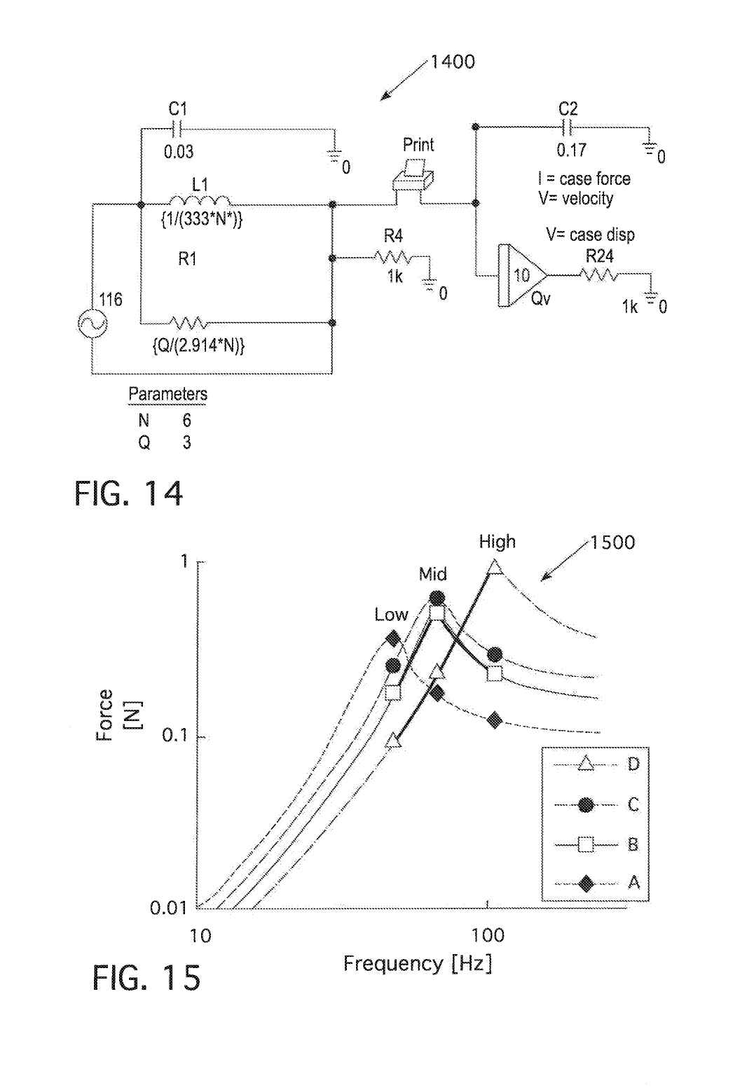

FIG. 14 is the mobility analog for the system in FIG. 13 as simulated in Personal computer Simulation Program with Integrated Circuit Emphasis (PSPICE). In this study, masses of the case 1208 and inertial mass 1206 were fixed, and the performance trade-offs of four candidate actuator configurations were assessed.

For each of the four candidate actuator, the PSPICE “IPWL_FILE” element was used to input sinusoidal forces ranging from 0.1 to 250 Hz. This identified the resonant frequency of each system. The click response of each system was determined by inputting one unipolar square-wave pulse with a duration that best excited the resonant frequency. Haptic tones representative of the performance envelope at low, medium, and high frequencies were determined by inputting sine waves of maximum force for 100 ms total duration with 10 ms allotted at the beginning and end of the tone to smoothly ramp amplitude. Some parameters of the candidate actuators are given below in TABLE 1. Systems A and B were the result of making haptic cartridges with fewer or more output bars while holding actuator volume constant. Systems C and D were made by stacking two A or B haptic cartridges, which doubled actuator volume, doubles blocked force, and raised resonant frequency by a factor of \sqrt{2}.

TABLE 1

| | | System Resonant Frequency |
|---|---|---|
| | Actuator Blocked Force (N) | (Hz) |
| A | 0.2 | 51 |
| B | 0.3 | 76 |
| C | 0.4 | 72 |
| D | 0.6 | 107 |

FIG. 15 is a graphical representation 1500 of frequency responses of the haptic systems A-D given in TABLE 1. The horizontal axis is Frequency (Hz) and the vertical axis is Force (N). The rectangles mark the frequencies of the tones users used to evaluate the systems. The steady state frequency responses of the systems were simulated in PSPICE, and are plotted in FIG. 15. System D (triangles) provided the greatest force in service, but only at the high frequency. Treble performance comes at the expense of bass. System A (diamonds) was the opposite, providing the best bass performance at the expense of treble. Systems B (squares) and C were mid-range. System C (black circles) provides ˜25% more force than B, at the cost of an additional haptic cartridge.

Physical prototypes were tested side-by-side using simulator hardware for playing the waveforms. To check the accuracy of the PSPICE simulation and the integrity of the output hardware, a case was prototyped, added weight to 170 g, and installed a 30 g inertial drive made with one of the four actuators under consideration, (B, in TABLE 1). This permitted side-by-side testing of a real system with the simulated counterpart. Frequency sweeps and single pulse clicks at resonant frequency were played through both systems as they rested on foam supports. Accelerations were measured with a ±2 g accelerometer with >1 kHz bandwidth (ADXL311, Analog Devices).

FIG. 16 is a graphical depiction 1600 of acceleration of the simulator and the prototype built with an actuator (B). The horizontal axis is Time (ms) and the vertical axis is Volts (V). As shown in FIG. 16, acceleration of the simulator matched the prototype built with actuator (B). Typical data for a click response showed the good match between the real and simulated systems, which may be difficult to distinguish in the figure due to superimposition. In all tests, the timing and magnitude of the accelerations agreed within 10%, indicating that the simulator was accurate enough for user testing.

FIG. 17 is a graphical depiction 1700 of acceleration of the simulator and the prototype built with an actuator (B). As shown in FIG. 17, acceleration of the simulator matched the prototype built with actuator (D). For thoroughness, a second system with a different candidate actuator (D) was prototyped and again it was found that the simulator provided a satisfactory match.

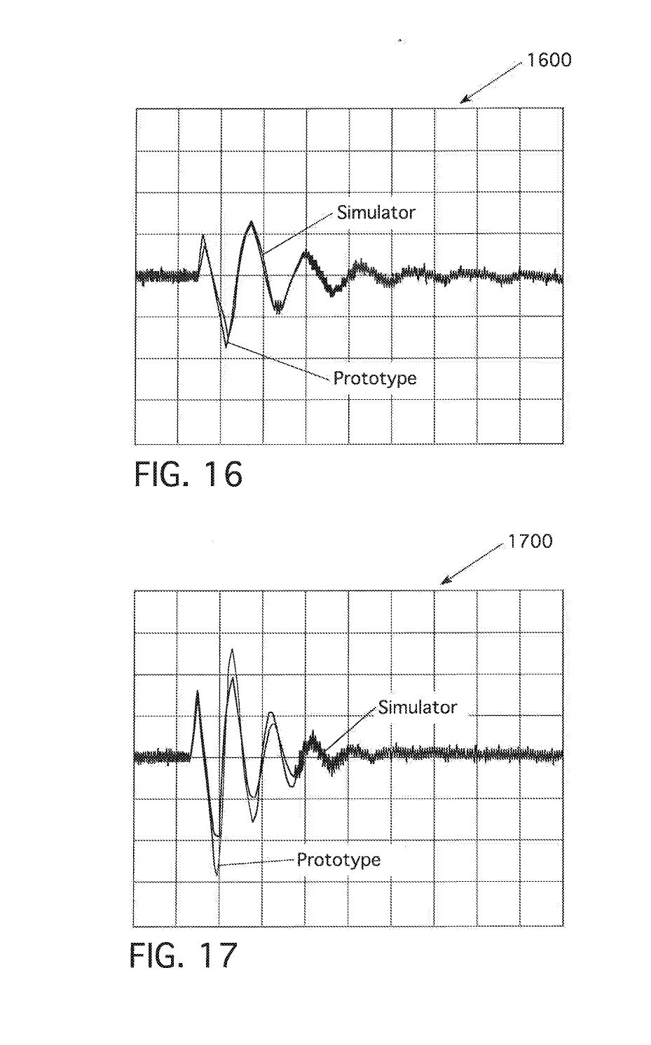

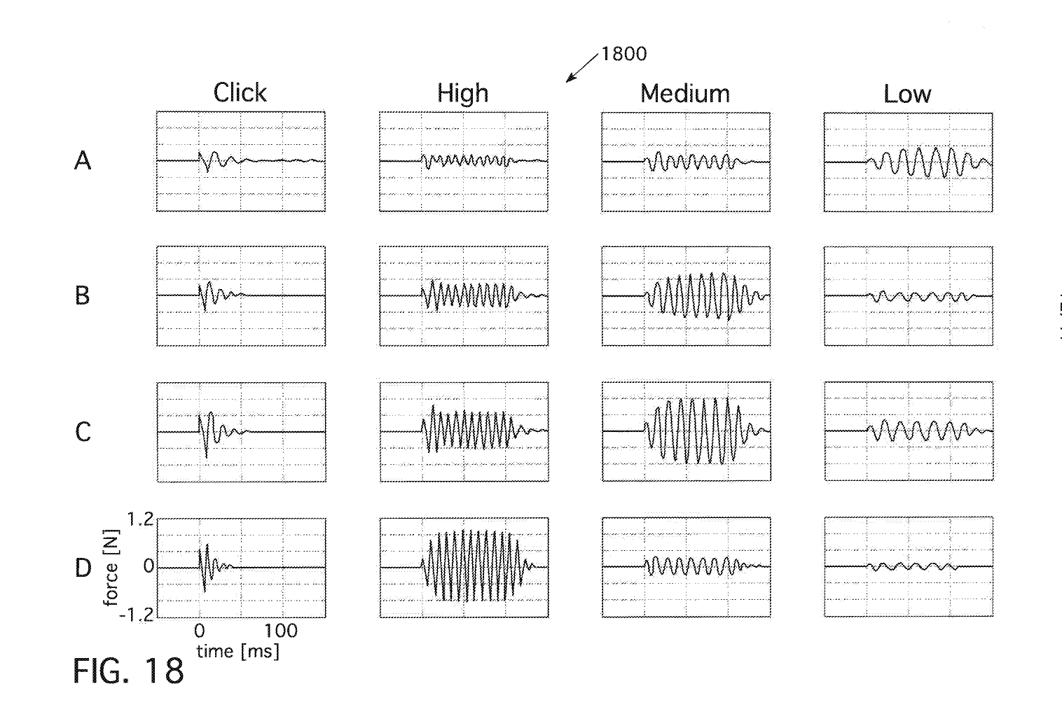

FIG. 18 illustrates waveforms 1800 used in a user study of a suitable actuator. At the start of testing, printed instructions were provided to each user. For each actuator A, B, C, D a different waveform was provided representing Click and High, Medium, and Low frequencies. Each waveform is plotted with Time (ms) along the horizontal axis and Force (N) along the vertical axis. The directions instructed the user to imagine that they were game designers and wanted to put haptic effects into a game being designed. These haptic effects included explosions, car crashes, bumpy roads, gun recoil, etc. The user was provided a choice of four different actuators A, B, C, D. Each actuator A, B, C, D produced a different tone: “Click”, “High”, “Medium”, and “Low.” Each actuator had some trade-off. It can play some frequencies more strongly than others. The user was instructed to think of each actuator as a piano. In the game, the user would be able to play any song (explosion), but a note cannot be played louder than some limit. The simulator shows the limit of each actuator A, B, C, D at three different frequencies low, medium, high, and also how strong a click it can make. The users rated each actuator according to how useful they thought it would be for making game effects without discussing the ratings with the other users. To facilitate comparison, a play-off design was used. Users were presented with two actuators (for example, A and B), and asked to choose a winner. They next compared the two remaining actuators (for example, C and D) and chose another winner. The two winning systems played off, so the user had chosen a preferred system. Likewise, the two losing systems played off, to provide a relative ranking from worst to best. Users ranked the systems based on clicks and 100 ms haptic tones.

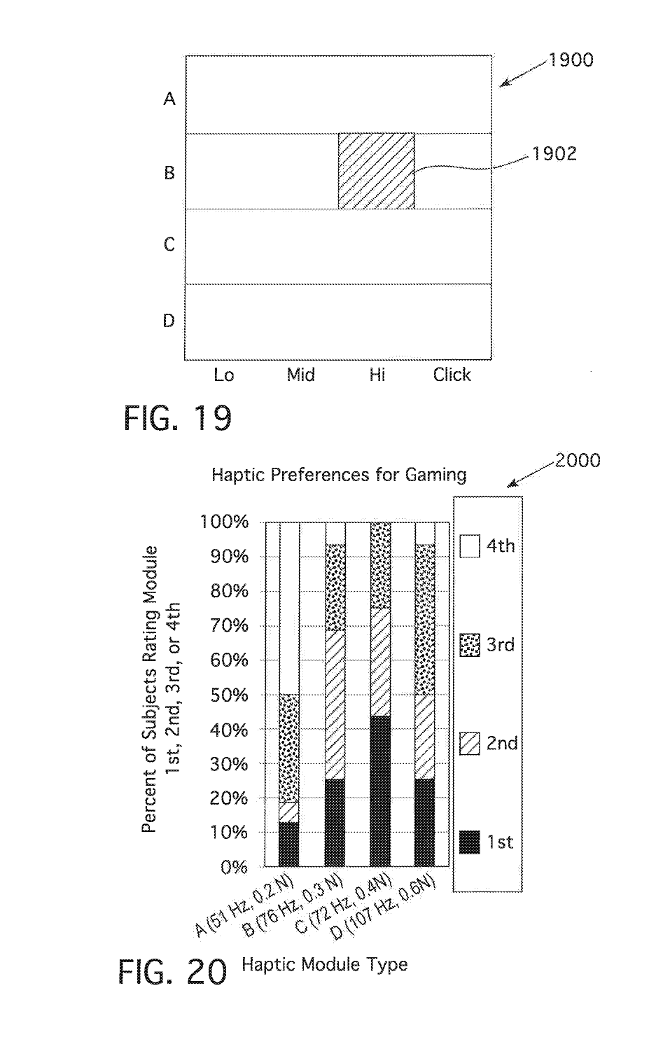

FIG. 19 is a screen shot of a graphical user interface 1800 (GUI) used to collect the data from each user. Lo, Med, Hi, and Click are provided along the horizontal axis for each actuator A, B, C, D is provided along the vertical axis, where Lo, Med, and Hi represent low, medium, and high frequency tones and Click represents click tone. A MATLAB script facilitated data collection. The users interacted with the simple GUI 1800, which highlighted squares 1902 of a grid to indicate which actuator A, B, C, D and effect was currently playing. Users controlled the initiation of trials, but not the timing or order of the haptic effects. Each effect was allotted the same time of about 100 ms with one second between presentations to avoid masking. Assignment of systems to rows 1-4 of the GUI 1800 varied between users and was made according to a balanced Latin-square design. At each stage of the ranking users were free to make as many comparisons as they wished in order to choose a preferred system.

To gauge the strength of their preferences for the different systems, users marked a line to indicate their satisfaction with their least favorite system. Haptic tones from each actuator they had ranked better were then presented in turn and the user indicated the degree of improvement relative to their first mark. The data were then normalized to each user's average ranking.

FIG. 20 is graphical representation 2000 of rank ordering of design options. The haptic module type A (51 Hz, 0.2 N), B (76 Hz, 0.3 N), C (72 Hz, 0.4 N), D (107 Hz, 0.6N) is provided along the horizontal axis and percent of subjects rating the module 1^{st}, 2^{nd}, 3^{rd} and 4^{th} is provided along the vertical axis. The haptic module type users preferred most often was haptic module type C, ranked first by 44% of users. It was ranked in the top two by 75% of users, closely followed by haptic module type B, which was ranked in the top two by 69% of users.

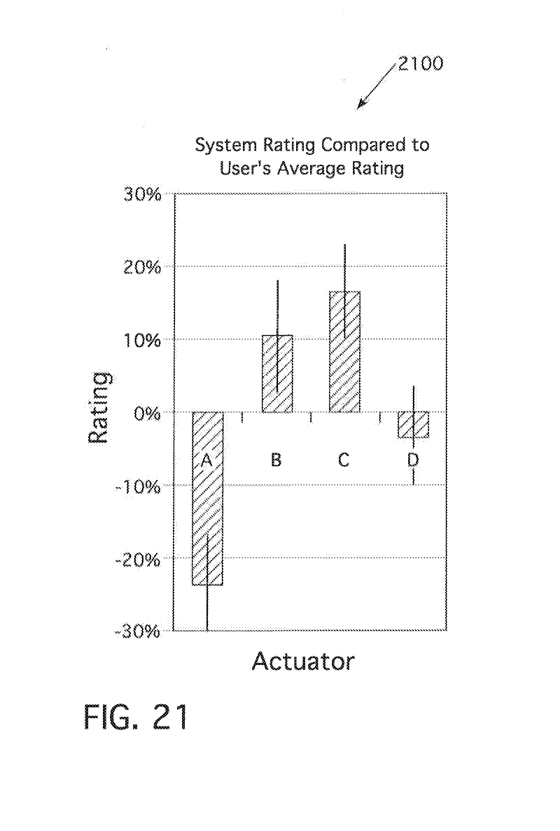

FIG. 21 is a graphical representation 2100 of strength of preferences, which provides system rating compared to user's average rating. Actuator type A, B, C, D is provided along the horizontal axis and Rating (%) is provided along the vertical axis. After rank-ordering their preferences, users indicated how strongly they liked or disliked various systems by marking a “least to most” rating line. The midrange systems rated about 10%-16% above average. The high frequency system ranked slightly below average and the lowest frequency system ranked about 23% below average.

Statistical tests of the user's ratings led to two conclusions: (1) There were two systems that users significantly preferred—the mid-range systems (B) and (C), (p<0.05); (2) The two mid-range systems (B) versus (C) were not significantly different in terms of user preference (p=0.10, N=16).

The user study showed users prefer mid-range haptic systems. Actuators providing a system resonance in the vicinity of 75 Hz were preferred over systems with higher (107 Hz) or lower (51 Hz) frequencies. It is significant that mid-range system (B) was preferred over the high frequency system (D), as (D) required twice as many haptic module cartridges, and could deliver twice the peak force. This suggests designing for high force at high frequency is not an optimal strategy for inertial drives. When an actuator design purchases high-frequency intensity at the expense of the lower frequencies, as design (D) did, the cost can outweigh the benefit. In post-test comments users observed that the mid-range systems “played all the effects well” while the other two systems, which they had ranked lower, “only played one effect well.” To be ranked highly, systems had to do a good job rendering all of the test frequencies. In light of this feedback, it is probably not sufficient to talk about actuators and handheld haptic devices simply in terms of “g's” of acceleration, although this is a common industry shorthand. A system might provide many g's of acceleration but only at one frequency, as is the case with eccentric mass motors. Even if a system has reasonable bandwidth, it may neglect the intensity of bass gaming effects in order to keep displacements small, which can be a pitfall of using brittle piezoelectric benders. User tests of candidate systems at multiple frequencies proved to be a useful design tool. With system models and simulator hardware, the present inventors could show users the performance envelopes of different designs. Measuring their preferences let one select the haptic module cartridge providing the performance users wanted.

The following references may prove useful in providing additional background material: Topi Kaaresoj and Jukka Linjama, Perception of Short Tactile Pulses Generated By A Vibration Motor In A Mobile Phone, Proceedings of the First Joint Eurohaptics Conference and Symposium on Haptic Interfaces for Virtual Environment and Teleoperator Systems 0-7695-2310-2/05 (2005); S. Biggs and R. Hitchcock, Artificial Muscle Actuators For Haptic Displays: System Design To Match The Dynamics And Tactile Sensitivity Of The Human Fingerpad, Proc. SPIE 7642, 764201 (2010); and Hong Z. Tan, Charlotte M. Reed, Lorraine A. Delhome, Nathaniel I. Durlach, and Natasha Wan, Temporal Masking Of Multidimensional Tactual Stimuli, Journal of the Acoustical Society of America, Vol. 114, No. 6, pp. 3295-3308, December 2003. Each of these references is herein incorporated by reference.

### Tablet Driving Concepts

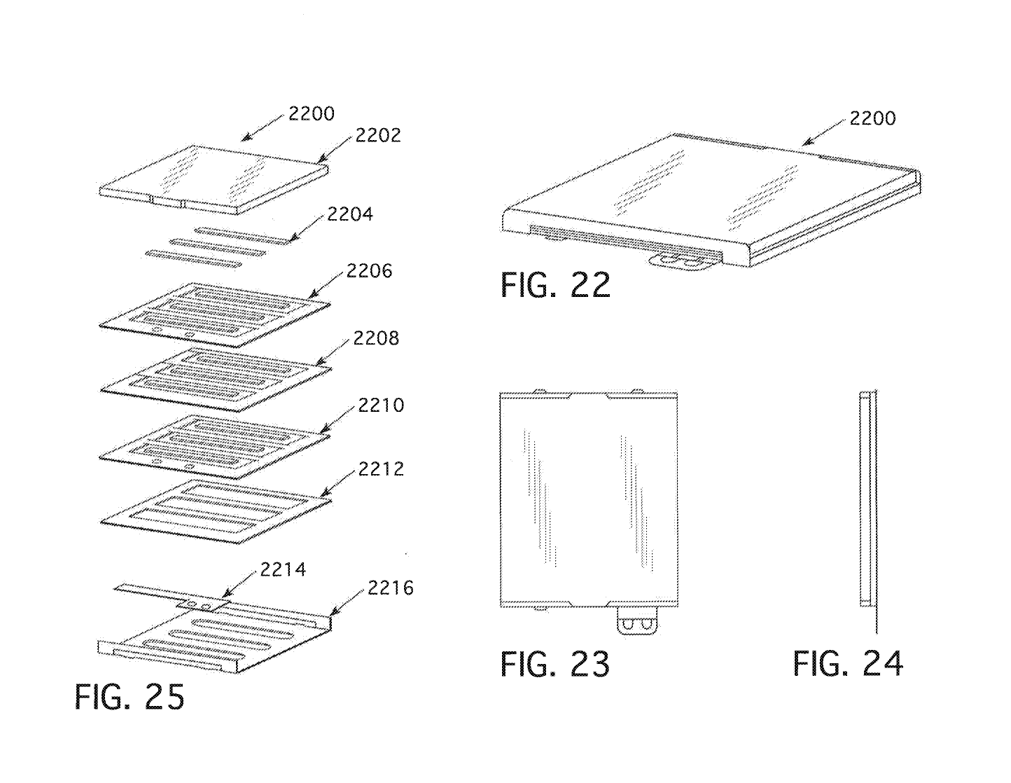

FIGS. 22-25 illustrate one embodiment of a haptic actuator 2200 layout for a tablet computer suspended inertia drive system. FIG. 22 is perspective view of the haptic actuator 2200. FIG. 23 is top view of the haptic actuator 2200. FIG. 24 is a side view of the haptic actuator 2200. FIG. 25 is an exploded view of the haptic actuator 2200. With reference to FIGS. 22-25, the haptic actuator 2200 comprises a 2× four-layer, three-bar haptic actuator module, brass mass material ˜20 g, and a mass suspended on sheet metal flexures. This is more clearly illustrated in the exploded view of FIG. 25. Haptic actuator cartridges 2206, 2210 comprising a three-bar haptic actuator are coupled using a stack adhesive 2208. Output bar adhesive 2204 couples the first actuator cartridge 2206 to an inertial mass 2202. A frame adhesive 2212 couples the second actuator cartridge 2210 to a base plate/mass suspension 2214. An FPC connection 2214 is provided between the base plate/mass suspension 2216 and the frame adhesive 2212.

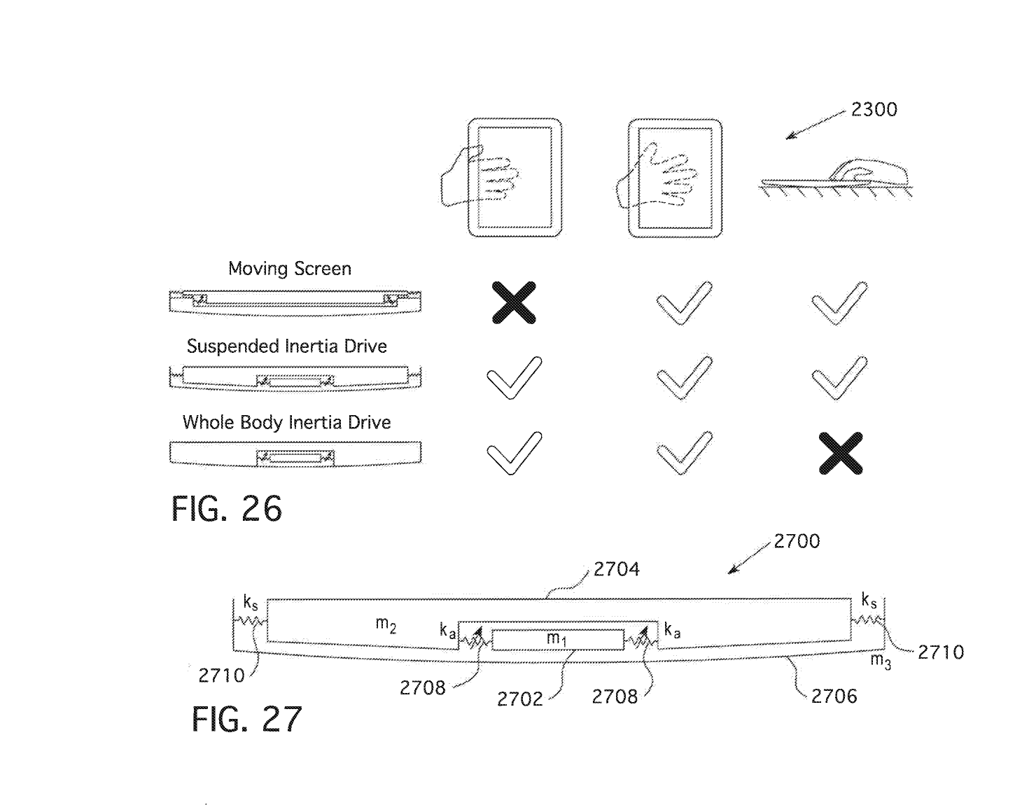

FIG. 26 provides a comparison of various drive systems for a tablet computer. These drive systems include a moving screen system, a suspended inertia drive system, and a whole body inertia drive system. As shown, only the suspended inertia drive system is suitable for all three use cases shown in the upper portion of FIG. 26 for a tablet computer. The suspended inertia drive system also performed better than the moving screen system and the whole body inertia drive system when considering ease of integration and user experience.

FIG. 27 is a diagram illustrating a suspended inertia drive system 2700 configuration for a tablet drive system. The suspended inertia drive system 2700 comprises an inertial drive mass 2702 (m₁), and a mass of internal components 2704 (m₂) including display, PCBs, battery, etc. A third mass 2706 (m₃) is the mass of the back-shell only. The suspended inertia drive system 2700 eliminates the need for flexible electrical connections, works in all use conditions with the most direct-to-finger haptics. The suspended inertia drive system 2700 actuator is integrated as a stand-alone module and provides an easy moving-screen integration as well as final assembly.

### Haptic Feedback Device for Gesticular Interfaces

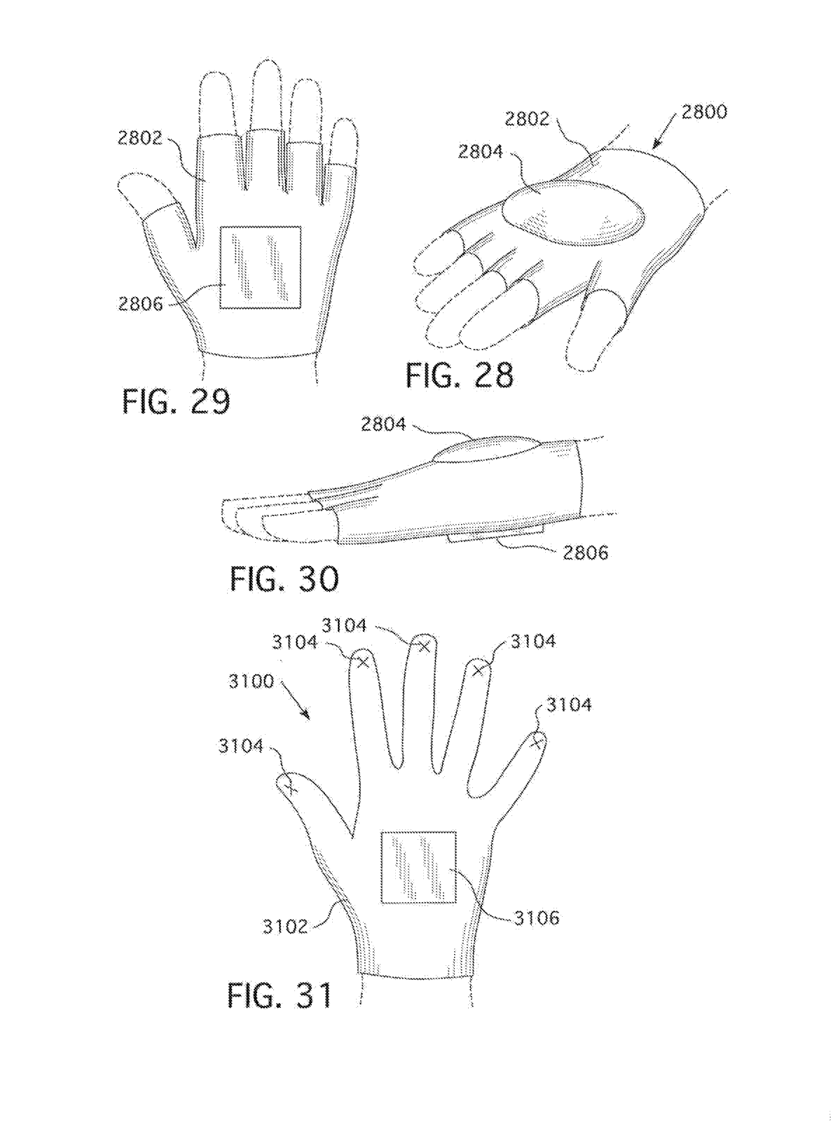

FIG. 28 illustrates one embodiment of a haptic feedback device 2800 for gesticular interfaces. The haptic feedback device 2800 adds a haptic or tactile feedback level of interactivity for the user of gesticular based interfaces. With the advent of camera and three dimensional scanning based input devices such as the Kinect sensor, the user uses his/her body parts to interact with UI elements or gameplay on the screen. While this adds a great level of interactivity for the user, it does take away the feedback of interacting with physical objects. So far the only feedback employed in similar systems is a rumble motor in Nintendo WII and PS3 control pendants that the user holds for both input and haptic feedback.

FIG. 28 is a perspective view of the haptic feedback device 2800. FIG. 29 is top view of the haptic feedback device 2800. FIG. 30 is a side view of the haptic feedback device 2800. With reference now to FIGS. 28-30, in one embodiment, the haptic feedback device 2800 comprises a glove 2802 or band that fits on or around the user's hand. The purpose of the glove 2802 or band is to contain and locate a haptic feedback actuator module 2806 close to the user's skin. There may be several haptic actuator modules 2806 to stimulate different parts of the hand. In one embodiment, the device 2800 is a fingerless glove 2802 with a single haptic actuator 2806 mounted or sewn into the palm area, connected to drive circuitry 2804 on the other side at the back of the hand. The actuator can have many form factors including planar, z-mode (surface deformation), and roll architectures.

FIG. 31 is another embodiment of a haptic feedback device 3100 comprising a full glove 3102 with smaller haptic actuator modules 3104 placed at the fingertips and haptic actuator modules 3106 placed on the palm. The haptic actuator modules 3104, 3106 may be either an electro active polymer powered inertia mass drive or a direct skin contact device. In the case of a direct skin contact device, this may be either an encased planar actuator or a z-mode actuator. The actuator may be large and cover many areas of the hand while being segmented internally to provide discrete zones of stimulation. In one embodiment, each hand would have its own drive circuit, battery powered and wirelessly controlled.

In various embodiments, the haptic feedback devices 2800, 3100 shown in FIGS. 28-31, comprise electroactive polymers for the purpose of providing haptic feedback. The low profile and wide dynamic range of the actuator make this a superior product than a similar glove with rotary vibratory motors. In the case of z-mode actuators being used, the thin, compliant sheet form factor makes these ideal for use in a body-contact type of arrangement.

In various embodiments, the haptic feedback devices 2800, 3100 shown in FIGS. 28-31 have a high dynamic range providing the ability to stimulate the user with a wide range of effects from soft to hard and smooth to sharp. These also have a fast response time providing instant effect implementation with low lag contribute to a better user experience. A thin form factor provides a non cumbersome device that does not catch clothing or looks out of place worn on the user. The haptic feedback devices 2800, 3100 are high efficiency devices that have low power draw since this is a battery powered device, with the battery being as small as possible.

Having described various embodiments of haptic actuators, it will appreciated that a variety of techniques and materials may be employed to fabricate such devices

Broad categories of previously discussed devices include, for example, personal communication devices, handheld devices, and mobile telephones. In various aspects, a device may refer to a handheld portable device, computer, mobile telephone, smartphone, tablet personal computer (PC), laptop computer, and the like, or any combination thereof. Examples of smartphones include any high-end mobile phone built on a mobile computing platform, with more advanced computing ability and connectivity than a contemporary feature phone. Some smartphones mainly combine the functions of a personal digital assistant (PDA) and a mobile phone or camera phone. Other, more advanced, smartphones also serve to combine the functions of portable media players, low-end compact digital cameras, pocket video cameras, and global positioning system (GPS) navigation units. Modern smartphones typically also include high-resolution touch screens (e.g., touch surfaces), web browsers that can access and properly display standard web pages rather than just mobile-optimized sites, and high-speed data access via Wi-Fi and mobile broadband. Some common mobile operating systems (OS) used by modern smartphones include Apple's iOS, Google's ANDROID, Microsoft's Windows Mobile and Windows Phone, Nokia's SYMBIAN, RIM's BlackBerry OS, and embedded Linux distributions such as MAEMO and MEEGO. Such operating systems can be installed on many different phone models, and typically each device can receive multiple OS software updates over its lifetime. A device also may include, for example, gaming cases for devices (iOS, android, Windows phones, 3DS), gaming controllers or gaming consoles such as an XBOX console and PC controller, gaming cases for tablet computers (IPAD, GALAXY, XOOM), integrated portable/mobile gaming devices, haptic keyboard and mouse buttons, controlled resistance/force, morphing surfaces, morphing structures/shapes, among others.

It is to be appreciated that the embodiments described herein illustrate example implementations, and that the functional elements, logical blocks, program modules, and circuits elements may be implemented in various other ways which are consistent with the described embodiments. Furthermore, the operations performed by such functional elements, logical blocks, program modules, and circuits elements may be combined and/or separated for a given implementation and may be performed by a greater number or fewer number of components or program modules. As will be apparent to those of skill in the art upon reading the present disclosure, each of the individual embodiments described and illustrated herein has discrete components and features which may be readily separated from or combined with the features of any of the other several embodiments without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is included in at least one embodiment. The appearances of the phrase “in one embodiment” or “in one aspect” in the specification are not necessarily all referring to the same embodiment.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It will be appreciated that those skilled in the art will be able to devise various arrangements which, although not explicitly described or shown herein, embody the principles of the present disclosure and are included within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, embodiments, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the exemplary embodiments and embodiments shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the invention and does not pose a limitation on the scope of the invention otherwise claimed. No language in the specification should be construed as indicating any non-claimed element essential to the practice of the invention. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

All documents cited in the Description are, in relevant part, incorporated herein by reference; the citation of any document is not to be construed as an admission that it is prior art with respect to the claims. To the extent that any meaning or definition of a term in this written document conflicts with any meaning or definition of the term in a document incorporated by reference, the meaning or definition assigned to the term in this written document shall govern

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments and appended claims.

What is claimed is:

1. A feedback enabled system, comprising:
a first feedback module comprising:
a thin film;
a frame;
a motion coupling, wherein, when a voltage is applied to the thin film, the motion coupling exerts a force on the frame to provide feedback; and
a user interface, wherein the first feedback module is configured to provide feedback through the user interface.

2. The feedback enabled system according to claim 1, wherein the thin film is one of a dielectric elastomer or a piezoelectric material.

3. The feedback enabled system according to claim 1, wherein the thin film is a dielectric elastomer selected from the group consisting of acrylates, silicones, urethanes, hydrocarbon rubbers, fluoroelastomers, styrenic copolymers, and combinations thereof.

4. The feedback enabled system according to any one of claims 1 to 3, wherein the motion coupling comprises one or more bars operatively coupled to the thin film, wherein the one or more bars extend through one or more openings defined by the frame.

5. The feedback enabled system of any one of claims 1 to 4, wherein the motion coupling is operatively coupled to an inertial mass.

6. The feedback enabled system according to claim 1, wherein the system has a resonant frequency of between about 72 Hz and about 76 Hz.

7. The feedback enabled system according to any one of claims 1 to 6, wherein the user interface further includes:
a wearable housing, wherein the thin film, the frame, and the motion coupling are mounted on the wearable housing.

8. The feedback enabled system according to any one of claims 1 to 7, wherein the feedback module is configured to provide haptic feedback.

9. The feedback enabled system according to claim 7, wherein the wearable housing is a glove.

10. The feedback enabled system according to any one of claims 1 to 9, wherein the first feedback module comprises one or more segmented sections, wherein the segmented sections are configured to provide discrete zones of feedback.

11. The feedback enabled system according to claim 7, wherein the feedback module is configured to provide vestibular feedback.

12. The feedback enabled system according to claim 11, further comprising:
a second feedback module, wherein the first and second feedback modules are actuated with one or more asymmetrical waveforms to create vestibular sensations.

13. The feedback enabled system according to claim 12, wherein the wearable housing positions the first and second feedback modules on opposite sides of a user's head.

14. The feedback enabled system according to claim 13, further comprising
a third feedback module;
a fourth feedback module; wherein the third and fourth inertial modules are actuated with one or more asymmetrical waveforms to create vestibular sensations, and wherein the third and fourth inertial modules are located at opposite sides of the wearable housing.

15. The feedback enabled system according to claim 13, wherein the user interface comprises one or more high-shear cushions, and wherein the one or more high-shear cushions are configured to transfer the vestibular feedback from the first and second feedback modules to the user.

16. The feedback enabled system according to claim 1, wherein the user interface comprises:
a touch screen display; and
wherein the first feedback module is operatively coupled to the touch screen display.

17. The feedback enabled system according to claim 16, wherein the first feedback module and the touch screen display comprise a suspended inertia drive.

18. The feedback enabled system according to claim 16, wherein the first feedback module and the touch screen display comprise a whole body inertia drive.

19. The feedback enabled system according to one of claims 1 to 18, further including:
a drive circuit operatively coupled to the thin film, wherein the drive circuit is configured to generate the voltage in response to one or more input signals.

20. A method for providing feedback to a user, the method comprising
applying a first voltage at a first waveform to a first feedback module, the first feedback module comprising a thin film, a frame, and a motion coupling, wherein, when the first voltage is applied to the thin film, the motion coupling exerts a force on the frame.

21. The method according to claim 20, further comprising:
applying a second voltage at a second waveform to a second feedback module, the second feedback module comprising a second thin film, a second frame, and a second motion coupling, wherein, when the second voltage is applied to the second thin film, the second motion coupling exerts a force on the second frame; and
wherein the first waveform and the second waveform are asymmetric.

22. A feedback module to provide feedback to a user, the feedback module comprising:
a thin film;
a frame defining one or more openings;
one or more bars operatively coupled to the thin film and extending through the one or more openings of the frame; and
a drive circuit operatively coupled to the thin film to provide a voltage to the thin film, wherein when the voltage is applied to the thin film, the one or more bars exert a force on the frame to provide feedback to the user.

23. A wearable vestibular display, comprising:
a first feedback module;
a second feedback module;
wherein the first and second feedback modules are driven with asymmetric waveforms to create vestibular sensations.

24. The wearable vestibular display according to claim 23, wherein the first and second feedback modules each comprise:
thin film actuators; and
inertial masses coupled to the thin film actuators.

25. The wearable vestibular display according to claim 24, wherein the thin film actuators comprise a material selected from the group consisting of dielectric elastomer thin films, piezoelectric thin films, or a combination thereof.

26. The wearable vestibular display according to any one of claims 23 to 25, wherein the first and second feedback modules each comprise a forward/back inertial drive module and an up/down inertial drive module.

27. The wearable vestibular display according to claim 26, wherein the first and second feedback modules are driven out phase with an asymmetric waveform to create a vestibular sensation consistent with rotational acceleration.

28. The wearable vestibular display according to claim 26, wherein the first and second feedback modules are driven out of phase with an asymmetric waveform to create a vestibular sensation consistent with linear acceleration.

29. The wearable vestibular display according to claim 23, comprising a head mounted system.

30. The wearable vestibular display according to claim 29, wherein the head mounted system comprises a cushion having a shear stiffness suitable for mechanical coupling of the head mounted system to a user's head.
